(19) United States
(12) Patent Application Publication
(10) Pub. No.: US 2005/0228715 A1
(43) Pub. Date: Oct. 13, 2005

(54) Management system for a parking site for vehicles

(76) Inventors: Michael Hartig, Munchen (DE); Mirko Wendler, Munchen (DE)

Correspondence Address: HARNESS, DICKEY & PIERCE, P.L.C., P.O.BOX 8910, RESTON, VA, 20195, US

(21) Appl. No.: 10/515,262

(22) PCT Filed: Mar. 31, 2003
(86) PCT No.: PCT/DE03/01056

§ 371 Date: Nov. 22, 2004

(30) Foreign Application Priority Data
May 21, 2002 (DE) 102 22 396.3

(51) Int. Cl. G06F 17/60

(52) U.S. Cl. 705/13

(57) ABSTRACT

A management system is for a parking site for vehicles with at least one parking zone including a plurality of parking places. The system includes an output device for data carriers that are to be carried by users of the site and equipment for reading and/or writing information on the data carriers, the output device and the read/write equipment being connected to a data processing centre. The read/write equipment interacts with passing data carriers within a specific remote action area, in such a way that data can be wirelessly transmitted in passing, thus allowing the displacement, the parking zone used and optionally even the occupied parking space to be tracked and the data to be made available in a centralized manner in the data processing centre and also in a decentralized manner on the data carrier of each individual user.

This application is the national phase under 35 U.S.C. § 371 of PCT International Application No. PCT/DE03/01056 which has an International filing date of Mar. 31, 2003, which designated the United States of America and which claims priority on German Patent Application number DE 102 22 396.3 filed May 21, 2002, the entire contents of which are hereby incorporated herein by reference.

### FIELD OF THE INVENTION

The invention generally relates to a management system for a vehicle car park which has at least one parking zone with a plurality of parking spaces preferably, it relates to one having an issuing device for data carriers which are to be carried by users of the car park and having devices for reading, and/or writing to, the data carriers, the issuing device and the read/write devices being connected to a data processing center.

### BACKGROUND OF THE INVENTION

The persistent trend toward individual methods/ways of transportation and the associated increasing density of vehicles are a challenge for car park technology, in particular in the high traffic density centers of conurbations. Parking guiding systems use dynamic displays to guide the drivers of vehicles to places where they can park such as car parks, multistory car parks or parking garages which still have free spaces for vehicles to park. In order to make optimum use of such car parks it is necessary to have an overview of their occupancy situation.

Owing to the size of such car parks, and their sometimes fluctuating use as well as the large number of possible individual locations of such car parks, for example at airports, railway stations, in shopping centers, hotels or on the premises of companies, managing the occupancy economically with a high occupancy rate presents significant problems. To do this, management systems are used which monitor the occupancy of parking spaces for vehicles. In the case of fully automatic systems, the parking period, the parking fee and the number of parking spaces available are signaled to a data processing center. The signaled data can be registered there, evaluated and passed on, via modem, to a superordinate parking control system.

Patent document DE 33 42 217 C2 discloses an arrangement for managing the occupancy of parking spaces in multistory car parks with a plurality of vehicle parking spaces. The arrangement at least includes, in each case, one entry and exit monitoring device which registers when a vehicle passes and signals this to a central memory and computing device. In addition, the arrangement includes sensor devices for registering the state of occupancy of parking space areas and display devices for directing the entering vehicles. Here, each individual vehicle parking space is assigned an individual sensor device which registers when it is occupied.

Display devices automatically show the incoming vehicles the way to a vehicle parking space which has been detected as being free, the display devices being controlled by a central memory and computing device, initiated by a vehicle passing the entry or exit barrier arrangement, as a function of the sensor signals of the individual vehicle parking spaces. A plurality of display devices are arranged along the routes which interconnect the vehicle parking spaces.

The sensor devices may be embodied as photoelectric barriers or as capacitive or inductive devices. By way of the central memory and computing device, a magnetic card writing and issuing device is provided at the entry barrier arrangement and a magnetic card reading and receiving arrangement is provided at the exit barrier arrangement. Furthermore, a device for sensing the size of the vehicle is arranged in the vicinity of the entry barrier arrangement.

Patent document EP 0 547 197 B1 discloses a system for managing a car park which is composed of at least one parking zone, each parking zone being composed of a plurality of parking spaces. The known system has in particular an individual and independent occupancy monitoring system for each parking space, a payment system for a parking fee and a signaling system. They are all connected to a data processing system. Furthermore, the management system has a passage detector which is assigned to each parking zone and is connected to the data processing system.

The parking fee payment system has at least one payment barrier which is equipped with a keyboard at which the number of the parking space is to be input. The number of the parking space can be input in conjunction with a code number which is known only to the user. The payment barrier can also have a registration device and a device for reading the parking space number, which device can be connected to a code number which is known to the user who is registered on a card or a ticket.

In this context, entry errors in respect of the parking space number can be displayed. If the correct code number has not been entered or read at the payment barrier, the data processing system triggers an alarm or blocks the vehicle if a detector indicates that the vehicle is driving off. The display system directs a user individually to at least one free parking space.

This individual display system includes, at each parking space, first and second light signals which indicate whether the space is free or occupied. In addition, a third light signal may be provided which indicates when the permitted parking period has been exceeded. The management system may also have a video monitoring system which takes an image of the registration plate of a vehicle which has exceeded the permitted parking period or for which the parking fee has not been correctly paid.

A disadvantage of the known management systems is finding the parked vehicle, in particular after a relatively long parking period, such as occurs, for example, during vacation journeys or extended business journeys, or in large multistory car parks with a large number of parking spaces which are arranged distributed over a plurality of parking floors. One approach to solving this problem, which is known from everyday life, is to provide slips of paper at the exit of a parking zone on which details about the car park and the respectively used parking zone in it are printed.

After the user has parked his vehicle, he can take such a slip of paper with him when he leaves the parking zone, and the slip of paper can be retained during the parking period and help the driver to find the parked vehicle after he has paid the parking fee. However, such slips of paper are frequently not available since the staff of the multistory car park have not restocked in good time, and restocking in itself can be very costly. In addition, the user may forget to take a slip of paper with him, or he may lose it during the parking period.

Apart from the usual ticket, which is typically registered when entering the car park, the slip of paper constitutes an additional item to be kept by the user. If the slip of paper is not available, the user is reliant solely on his memory when looking for his parked vehicle since the information about the parking zone which he has used or the occupied parking space is not managed centrally and cannot be called up in the event of a loss.

### SUMMARY OF THE INVENTION

An embodiment of the invention is therefore based on an object of providing a management system for a vehicle car park.

An object may be achieved according to an embodiment of the invention by virtue of the fact that the read/write devices of a management system of the generic type interact with passing data carriers within the specific telecontrol range in such a way that data can be transmitted in a wire-free fashion when a data carrier passes. By appropriately configuring the data carriers to be carried by a user and by suitably distributing read/write devices in the car park, a management system is provided which has an intelligent supplementary feature for the management of multistory car parks and which registers when an individual data carrier passes a specific read/write device, and the information from the respective device which the data carrier passes is written to the data carrier and the information from the passing data carrier can be read by the device and passed on to the data processing center of the system.

This permits a data carrier to be tracked on the way to the parking space within the car park. The tickets which are used as car park tickets can advantageously be developed as data carriers so that there is no need for an additional element to make this information available. By virtue of the distribution of the read/write devices, it is possible to track the route of a user, who is carrying a data carrier assigned to him, to his selected parking zone or even to his selected parking space and to record it centrally in the data processing center and in a decentralized fashion on the data carrier. With this information, the parked vehicle can easily be found again when the user returns to the car park.

In one preferred embodiment of the invention, a data carrier has a transceiver device for transmitting data via electromagnetic radiation, a microprocessor for processing the transmitted data and a storage device for the transmitted data. In particular the identification cards which are known per se and which have a transponder in the radio wave range are suitable for this. Such cards are practical since they are in the customary cheque card format. They are supplied with energy by way of the electromagnetic radiation of the read/write devices and include a memory which can be overwritten so that the transponder card can be re-used after it has been returned to circulation in the system.

In one advantageous embodiment of the invention, user data can be written by the issuing device to a data carrier which is to be issued. When the user enters the car park, he can request a data carrier to which user-specific data such as an identifier, the date and the time of entry as well as information about the car park used can be written in the issuing device. If the management system makes further options available to the user, for example the hire of a parking space, the selection of a parking space for the disabled, parking zones with different tariffs or for different heights of vehicle, this information can also be written to the data carrier by way of appropriate data.

In one preferred embodiment of the invention, read/write devices are arranged in the region of an entrance and/or exit of a parking zone so that when the data carrier which is carried by the user passes on the way to a parking space, the respective read/write device and the passing data carrier can register this and pass it on to the data processing center. As a result data indicating the parking zone in which a specific data carrier, and thus the user carrying the carrier, is located can be called centrally at any time. This data may be used at least for orientation purposes and can be employed by the data processing center for statistical evaluation purposes.

In one advantageous embodiment of the invention, read/write devices are arranged in a parking zone or at a parking space so that, after a parking space has been occupied, the presence of the data carrier which is carried by the user can be registered by the respective read/write device and by the data carrier which is present and can be passed on to the data processing center, the read/write devices having means for confirming that registration has taken place.

Such read/write devices are conceived of as being terminals at which a user can register the fact that he has finally reached his parking space. The read/write devices may be of a shorter telecontrol range than the read/write devices which are installed in the lanes and register the passing of a vehicle so that the user carries out this registration process intentionally. For this purpose there is provision that after the user leaves his parked vehicle he does not have to hold the carried data carrier in front of the device at a distance which is short enough to enter the relatively short telecontrol range in order to exchange data.

As soon as the parking space information has been written to the data carrier and his identity has been read out, the user receives an acknowledgement signal. This can be, for example, in the form of a beep tone, from the confirmation device.

This information can be used by the data processing center to prevent a subsequent exchange of data of the data carrier with read/write devices so that routes followed by the data carrier, carried by the user as he leaves the car park on foot, are excluded from this.

In a further preferred embodiment of the invention, reading devices with a display device are arranged in a parking zone, and information—stored on a data carrier—about the used parking zone or the occupied parking space can be output and displayed by way of the display device. As a result, it is possible for the user to verify the information about the occupied parking space which is written on the data carrier by holding the data carrier in the telecontrol range of this device and checking the number of the parking zone or of the parking space on a display on the device. These devices are preferably arranged at strategic positions such as accesses to lifts or staircases so that the verification process can be carried out before the user leaves the parking zone which he has used.

In a further advantageous embodiment of the invention, a payment device is provided for paying parking fees by way of the data carrier, which payment device includes a device for playing back the position of the used parking zone or of the occupied parking space in the car park. The payment device may be embodied in the form of a read/write device with a telecontrol range into which the data carrier has to be introduced for data to be transmitted in both directions. Alternatively it is also possible to provide a payment device into which the data carrier has to be mechanically inserted through a slot.

In all cases, the current date and the current time are recorded and the parking period determined from them. The parking fee which is due, and which the user then has to pay, is calculated from this using various tariff zones. After the fee has been paid, information about the location of the parking zone which has been used or the parking space which has been occupied is played back to the user, for example when requested by him.

An electronic display or a printout of a location diagram on which the parking space information which is stored in the data processing center can be seen are examples of playback devices. Depending on the size and layout of the car park, this information may be an identifying letter for a zone or the number of a parking space or a graphic layout diagram. This simplifies the search for the parked vehicle significantly, particularly when the user has been absent for a relatively long time.

In a further preferred embodiment of the invention, light signal device(s) which can be activated after the parking fee for a parking space has been paid are installed at the parking space. It is used in a particularly advantageous way in management systems in which the occupancy of individual parking spaces is monitored, for example by way of ultrasonic detectors. In such systems, lighting device(s) are installed over each parking space and, for example, they light up green when the parking space is free and red when it is occupied.

In this context it would also be possible to provide LEDs which flash red/green and which start to light up as soon as the user has paid his parking fee and is on the way to his vehicle. This visual signal makes the user entering a parking zone immediately aware of the position of his parking space. Alternatively, the light signal device(s) could also be provided on an overview panel in the vicinity of the payment device so that after the parking fee has been paid the zone in which the parking space which is assigned to the data carrier is located lights up.

In a further advantageous embodiment of the invention, the issuing device is designed to issue, as a pair, a first data carrier which is to be carried by the user and a second data carrier which is assigned to the data carrier and is provided to stay in the parked vehicle. Further, a monitoring device which is connected to the data processing center, is embodied in such a way that an exit from the car park is not cleared until after the parking fee has been paid and after the pair of data carriers which are assigned to one another have been returned. This embodiment constitutes a barrier against a vehicle being driven away without permission. The vehicle is allowed to drive out of the car park only if the driver is in possession of both transponder cards, has paid with the first and returns both to the monitoring device.

A monitoring device is preferably provided which triggers the photographing of the vehicle or user located at the monitoring device and/or triggers an alarm signal if the second data carrier is not returned or if a second data carrier which is not assigned to the first data carrier is returned. As a result, if data carriers are not returned satisfactorily, a video recording or a photograph of a possible vehicle thief is produced, which may be helpful during later investigations. An audible alarm signal in such a situation makes other users of the car park aware and can contribute to apprehending the thief or can cause him to flee, thus preventing a theft.

### BRIEF DESCRIPTION OF THE DRAWINGS

An exemplary embodiment of the invention will be explained in more detail below with reference to the drawings, which are given by way of illustration only and thus are not limitative of the present invention, in which:

FIG. 1 shows a data carrier according to an embodiment of the invention, and

FIG. 2 shows a data carrier passing a read/write device according to an embodiment of the invention, both in schematic views.

### DETAILED DESCRIPTION OF THE EXEMPLARY EMBODIMENTS

In the exemplary embodiment, a multistory car park is assumed which has parking zones distributed over a number of floors with a large number of parking spaces. A signaling system in conjunction with an occupancy monitoring system for each individual parking space ensures that the user can find his parking space as quickly as possible while he is sitting in his vehicle. At the same time, the traffic in the multistory car park which occurs in conjunction with the search for parking spaces is considerably reduced.

A signaling system with direction arrows and traffic lights can enable the multistory car park to be utilized in an optimum way. The displays are designed in such a way that they can be seen clearly from afar by any user. Parking zones or other subdivisions of the car park for various groups of users, such as short-term parkers, leaseholders, people renting spaces, local residents or disabled people, can thus be coordinated and managed. Each parking space is sensed here by ultrasonic sensors. All the information is fed continuously to a data processing center which indicates the fastest possible way to a free parking space to the user.

In addition to optimum utilization of a multistory car park, this increases the user satisfaction and reduces emissions of pollutants by minimizing the traffic involved in searching for a space. Hitherto, when a driver is parked in such a multistory car park, tickets were issued in the form of magnetic cards on which the date and time of entry were written. Before the driver left, this magnetic card was used to pay the parking fee, after which the exit was cleared on return of the ticket.

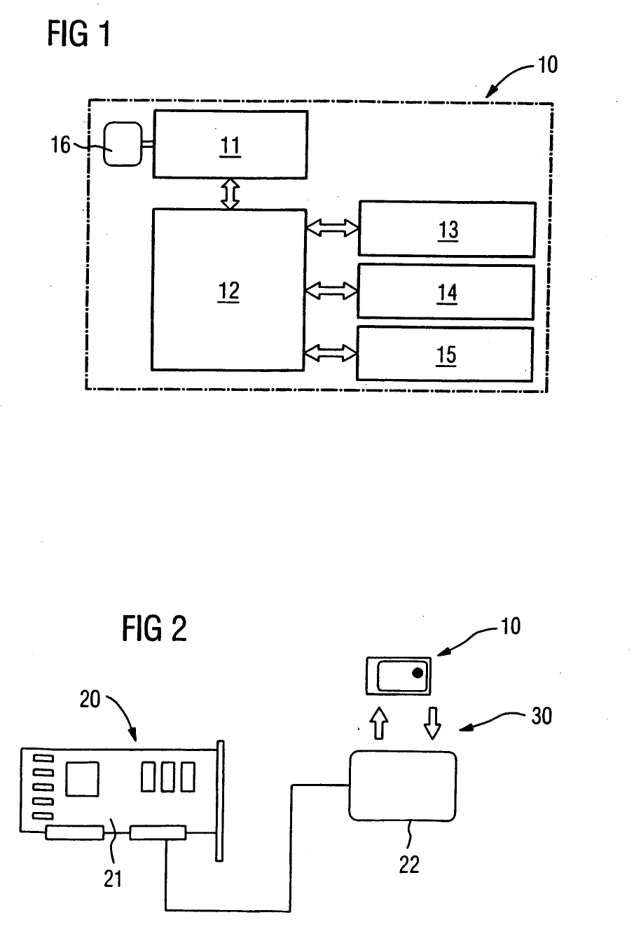

According to an embodiment of the invention, data carriers 10 which are embodied as transponder cards which are known per se and which have associated devices 20 for reading, and/or writing to, these data carriers 10 are used. According to FIG. 1, such a data carrier 10 includes an analog circuit component 11 for transmitting data and supplying power and a microprocessor with control and security logic features as digital circuit component 12. Furthermore, the data carrier 10 has a permanent memory 13, a read-only memory 14, on which, for example, an identifier of the card is stored, and a main memory 15, to which transmitted data can be written and from which data which is to be transmitted can be read. The data carrier 10 receives and transmits transmitted data via an antenna 16.

Devices 20 for reading, and/or writing to, the data carrier 10 are arranged at a wide variety of locations in the multistory car park. According to FIG. 2, a read/write device 20 includes a housing 21 having electronic components, and an antenna 22 for exchanging data with a data carrier 10. Data is exchanged by way of electromagnetic radiation in the radio wave range. To do this, the antenna 16 of the data carrier 10 must enter the telecontrol range 30 of the read/write device 20, that is to say the transmission and reception range of the antenna 22. The size of this telecontrol range 30 may be varied depending on the transmission and reception power of the device 20.

When a driver enters the multistory car park, two data carriers 10 and 10′ are issued by an issuing device and, for the purpose of mutual assignment, have identifiers written to them which are matched to one another, as well as the date and the time of entry and information about the multistory car park used. If appropriate, further data about the target parking space which is desired by the user or an unusual vehicle height can be written to the data carrier 10 or 10′ in accordance with a request or entry by the user. The barrier then opens and a guiding system guides the user through the multistory car park to a parking zone with free parking spaces. Green LEDs light up over the free parking spaces and red ones light up over parking spaces which are occupied by vehicles.

A read/write device 20 is arranged in each parking zone at the entries and exits. The read/write device 20 registers the vehicles passing by, to be more precise the data carriers 10 and 10′, respectively, which are carried by the user in the vehicle. In this context, the read/write device 20 reads the identifier of the passing data carrier 10 and passes on this information to a data processing center (not illustrated). At the same time, information about the parking zones traveled through is written to the data carrier 10.

After the user has reached his parking space and has parked the vehicle, he continues to carry the first data carrier 10 on his person, while the second data carrier 10′ remains in the vehicle. He holds the carried data carrier 10 in front of a read/write device 20 which is arranged at the parking space, in order to allow his ultimate parking position to be registered by an exchange of data. As a check, the data processing center can include the information about the parking zones previously traveled through.

This registration process has to be completed by the user in a conscious way by him holding the data carrier 10 a short distance away from the front of the read/write device 20 which has a short telecontrol range 30. After registration has taken place, the user is informed of the exchange of data by confirmation means, for example in the form of a beep tone or flashing LED.

In a more convenient variant of the management system, it is sufficient to provide such a read/write device 20 with a confirmation device only in every parking zone. This registration procedure which registers that the ultimate parking space has been reached can also be used to exclude subsequent routes which this data carrier 10 takes to read/write devices 20, for example when the user leaves the car park on foot.

Further read devices 20 with display devices on which the memory content of the data carrier 10 can be verified can be arranged at lift exits or exits from staircases of the parking zone.

After the parking fee which is due has been paid at a payment device, the data processing center of the management system searches for the parking zone or the parking space by means of the identifier of the data carrier 10, after which the user receives a printout of this which indicates which parking space and/or which parking zone he is using and where this parking space or zone is located in the multistory car park.

When the user arrives in the parking zone, for example a yellow/red LED flashes above the occupied parking space so that he quickly finds his vehicle. The light signal device(s) are configured here in such a way that they can be seen clearly from afar by any user.

At the exit, the first data carrier 10, together with the second data carrier 10′, is then returned into a monitoring device. In the monitoring device, checking is performed, using the data available in the data processing center, to determine whether the parking fee which is due has been completely paid with the first data carrier 10 and whether the second data carrier 10′ was assigned to the first data carrier 10. If the result of the check is positive, the exit is cleared for this user by, for example, a barrier arrangement clearing the passage. If the result is negative, the exit remains blocked.

If the parking fee is not paid, or an insufficient amount is paid, the user can be requested to pay the parking fee fully, and to do this the two data carriers are returned to him. If two data carriers which are not assigned to one another are returned, this could be considered as an attempt to steal a vehicle. In this case, at the initiative of the operator of the multistory car park it is possible to trigger an audible alarm signal and/or a video recording of the possibly stolen vehicle. The exit is also not cleared.

This management system with two data carriers which are assigned to one another not only provides the monitoring function described above but also prevents a data carrier being returned in isolation into the circulation of the system and thus having new data written to it if the registration after the parking space has been finally reached does not function or the user is moving on foot in the lanes or junctions between the parking zones.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A management system for a vehicle car park which has at least one parking zone with a plurality of parking spaces, comprising:
data carriers, for users of the car park;
read/write devices for at least one of reading from and writing to the data carriers, the read/write devices being adapted to interact with passing data carriers within a specific telecontrol range in such a way that data is transmittable in a wireless fashion when a data carrier passes, wherein the data carriers include an issuing device; and
a data processing center with which the issuing device and the read/write devices are connected, the read/write devices being arranged at least one of in a parking zone and at a parking space so that, after a parking space is occupied, the presence of the data carrier of the user is registered by the respective read/write device and is passed on to the data processing center.

2. The management system as claimed in claim 1, wherein a data carrier includes a transceiver device for transmitting data via electromagnetic radiation, a microprocessor for processing the transmitted data and at least one storage device for storing the transmitted data.

3. The management system as claimed in claim 1, wherein the issuing device is adapted to write user data to a data carrier which is to be issued.

4. The management system as claimed in claim 1, wherein the read/write devices are arranged in the region of at least one of an entrance and exit of a parking zone so that when the data carrier of the user passes on the way to a parking space, the respective read/write device and the passing data carrier register this and pass it on to the data processing center.

5. The management system as claimed in claim 1, wherein the read/write devices include means for confirming that registration has taken place.

6. The management system as claimed in claim 1, wherein the reading devices with a display device are arranged in a parking zone, and information, stored on a data carrier, about at least one of the used parking zone and the occupied parking space are adapted to be output and displayed via said display device.

7. The management system as claimed in claim 1, wherein a payment device is provided for paying parking fees via the data carrier, the payment device including means for playing back the position of at least one of the used parking zone and the occupied parking space in the car park.

8. The management system as claimed in claim 7, wherein light signal devices, adapted to be activated after the parking fee for a parking space has been paid, are installed at said parking spaces.

9. The management system as claimed in claim 1, wherein the issuing device is designed to issue, as a pair, a first data carrier of the user and a second data carrier, assigned to the first data carrier and provided to stay in the parked vehicle, and wherein a monitoring device, connected to the data processing center, is embodied in such a way that an exit from the car park is not cleared until after the parking fee has been paid and after the pair of data carriers have been returned.

10. The management system as claimed in claim 9, wherein a monitoring device is provided which at least one of triggers the photographing of at least one of the vehicle and user located at the monitoring device, and triggers an alarm signal if at least one of the second data carrier is not returned and if a second data carrier which is not assigned to the first data carrier is returned.

11. The management system as claimed in claim 2, wherein the issuing device is adapted to write user data to a data carrier which is to be issued.

12. A management system for a vehicle car park which has at least one parking zone with a plurality of parking spaces, comprising:
an issuing device for data carriers to be carried by users of the car park;
reading devices for reading the data carriers; and
a data processing center, wherein the issuing device and the reading devices are connected to the data processing center, and the reading devices are adapted to interact with passing data carriers within a specific range in such a way that data is transmittable in a wireless fashion when a data carrier passes, and wherein the reading devices are also designed to write to the data carriers, and the issuing device is designed to issue, as a pair, a first data carrier to be carried by the user and a second data carrier assigned to the first data carrier and is provided to stay in the parked vehicle, and wherein a monitoring device, connected to the data processing center, is embodied in such a way that an exit from the car park is not cleared until after the parking fee has been paid and after the pair of data carriers assigned to one another have been returned.

13. The management system as claimed in claim 12, wherein a monitoring device is provided which at least one of triggers the photographing of at least one of the vehicle and user located at the monitoring device and triggers an alarm signal, if at least one of the second data carrier is not returned and if a second data carrier not assigned to the first data carrier is returned.

14. The management system as claimed in claim 12, wherein a data carrier includes a transceiver device for transmitting data via electromagnetic radiation, a microprocessor for processing the transmitted data and at least one storage device for storing the transmitted data.

15. The management system as claimed in claim 12, wherein user data is adapted to be written by the issuing device to a data carrier to be issued.

16. The management system as claimed in one of claims 12, wherein read/write devices are arranged in the region of at least one of an entrance and exit of a parking zone so that when the data carrier which is carried by the user passes on the way to a parking space, the respective read/write device and the passing data carrier being adapted to register this and pass it on to the data processing center.

17. The management system as claimed in claim 12, wherein read/write devices are arranged in at least one of a parking zone and at a parking space so that, after a parking space has been occupied, the presence of the data carrier carried by the user is adapted to be registered by the respective read/write device and by the data carrier which is present and is adapted to be passed on to the data processing center, the read/write devices including means for confirming that registration has taken place.

18. The management system as claimed in claim 12, wherein reading devices with a display device are arranged in a parking zone and information, stored on a data carrier about at least one of the used parking zone and the occupied parking place, is adapted to be output and displayed via said display device.

19. The management system as claimed in claim 1, wherein a payment device is provided for paying parking fees by use of the data carrier, the payment device including means for playing back the position of at least one of the used parking zone and the occupied parking place in the car park.

20. The management system as claimed in claim 19, wherein a light signal devices, activated after the parking fee for a parking place has been paid, are installed at said parking spaces.

21. A management system for a vehicle car park which has at least one parking zone with a plurality of parking spaces, comprising:
data means for users of the car park to carry data;
read/write means for at least one of reading from and writing to the data carriers, the read/write means being adapted to interact with data means in such a way that data is transmittable in a wire-free fashion when a data carrier passes; and
means for processing data, wherein the read/write means are arranged at least one of in a parking zone and at a parking space so that, after a parking space is occupied, the presence of the data means of the user is registered by the respective read/write means and is sent to the means for processing data.

22. The management system as claimed in claim 21, wherein a data means includes means for transmitting data via electromagnetic radiation, means for processing the transmitted data and means for storing the transmitted data.

23. The management system as claimed in claim 21, wherein the data means includes an issuing means for writing user data to a data means which is to be issued.

24. The management system as claimed in claim 21, wherein the read/write means are arranged in the region of at least one of an entrance and exit of a parking zone so that when the data carrier of the user passes on the way to a parking space, the respective read/write means and the passing data means register this and pass it on to the means for processing data.

25. The management system as claimed in claim 21, wherein the read/write means include means for confirming that registration has taken place.

26. The management system as claimed in claim 21, wherein display means is arranged in a parking zone, and information stored on a data means, about at least one of the used parking zone and the occupied parking space, is adapted to be output and displayed via said display means.

27. The management system as claimed in claim 21, wherein a payment means is provided for paying parking fees via the data means, the payment means including means for playing back the position of at least one of the used parking zone and the occupied parking space in the car park.

28. The management system as claimed in claim 27, wherein light signal means for being activated after the parking fee for a parking space has been paid, are installed at said parking spaces.

29. The management system as claimed in claim 21, wherein a first data means of the user and a second data means, assigned to the first data means and provided to stay in the parked vehicle, are issued as a pair, and wherein a monitoring means is for monitoring an exit of a vehicle from the car park so as to not clear the vehicle until after the parking fee has been paid and after the pair of data means have been returned.

30. The management system as claimed in claim 29, wherein a monitoring means at least one of triggers the photographing of at least one of the vehicle and user located at the monitoring means, and triggers an alarm signal, if at least one of the second data means is not returned and if a second data means which is not assigned to the first data means is returned.
